(19) United States
(12) Patent Application Publication
(10) Pub. No.: US 2014/0085288 A1
(43) Pub. Date: Mar. 27, 2014

(54) DISPLAY DEVICE AND DRIVING METHOD THEREOF

(71) Applicant: SAMSUNG DISPLAY CO., LTD., Yongin-City (KR)

(72) Inventors: Utah CHOI, Cheonan-si (KR); Soon Kyoung KWON, Seoul (KR); Jin Woo PARK, Cheonan-si (KR); Hyo-Chul LEE, Cheonan-si (KR); Young Soo CHOI, Hwaseong-si (KR)

(73) Assignee: SAMSUNG DISPLAY CO., LTD., Yongin-City (KR)

(21) Appl. No.: 13/740,668

(22) Filed: Jan. 14, 2013

(30) Foreign Application Priority Data
Sep. 26, 2012 (KR) 10-2012-0107314

(51) Int. Cl. G09G 3/36

(52) U.S. Cl. CPC G09G 3/3648
USPC 345/212; 345/96

(57) ABSTRACT

A display device includes a display panel including a gate line, a data line, and a pixel connected to the gate line and the data line, a signal controller generating control signals for driving the display panel including a data load timing signal, a gate driver applying a gate voltage to the gate line, and a data driver applying a data voltage to the data line according to the data load timing signal received from the signal controller, wherein the data load timing signal includes a first load signal pulse and a different second load signal pulse, and where a width of the second load signal pulse is larger than a width of the first load signal pulse.

### CROSS-REFERENCE TO RELATED APPLICATION

This application claims priority to and the benefit of Korean Patent Application No. 10-2012-0107314 filed in the Korean Intellectual Property Office on Sep. 26, 2012, the entire contents of which application are incorporated herein by reference.

### BACKGROUND

(a) Field of Disclosure

The present disclosure of invention relates to a display device and a driving method thereof. More particularly, the present invention relates to a display device that is driven by a polarity reversal scheme and to a method of preventing luminance defects.

(b) Description of Related Technology

Currently, display devices are extensively used in computer monitors, televisions, mobile phones, and the like. Examples of display devices include a cathode ray tube display device, a liquid crystal display, a plasma display device, and the like.

A liquid crystal display (LCD) is currently one of the most widely used flat panel displays. It typically includes two spaced apart display panels on which respective field generating electrodes such as a pixel electrode and a common electrode are formed and a liquid crystal layer that is disposed therebetween. The LCD shows an image by applying voltage across a set of field generating electrodes to thereby generate an electric field in the liquid crystal layer. This determines alignment of liquid crystal molecules of the liquid crystal layer and controls polarization of incident light. The electrically controled polarization is used to form a desired image.

More specifically, the typical liquid crystal display includes the set of display panels and a signal controller. The signal controller transfers image data of a screenful of to be displayed pixels to electronic drivers of the display panels. The transfered image data generally includes control signals for driving the display panels through corresponding gate drivers and data drivers that are operatively coupled to gate lines and data lines of the display device.

More specifically, a plurality of gate lines and a plurality of data lines are formed to cross each other on one of the display panels, and pixel units connected to the gate lines and the data lines are formed. The gate lines are connected to respective gate electrodes of the pixel units that receive corresponding gate signals, and the data lines are connected to respective data or source electrodes that receive respective data signals.

In a case where data line voltages having a same polarity (relative to a common voltage, i.e. a Vcom of about +4.7V above ground) are continuously applied, the liquid crystal display has a problem in that a liquid crystal material can become degraded. A driving method including that of inverting the polarities of the voltages between frames, for each display line, and for each pixel has been proposed in order to prevent this degradation phenomenon of liquid crystal.

The polarity inversion between frames may occur, as shown for example in FIG. 1, by inverting the polarity of the data voltages every one frame (thin plot line), or every two frames (darkened and bolded plot line), etc.

More specifically, FIG. 1 is a graph showing a voltage that comes to be charged on a pixel electrode of a specific pixel in the case where driving method includes that of inverting the polarity of the data voltage every one frame (thin plot line) and also in the case where driving is performed by inverting the polarity of the data voltage every two frames (darkened and bolded plot line). In FIG. 1, an overlapping portion where the same polarity and magnitude (e.g., about +7.0 volts) is present for both the case of one frame inversion and the case of two frame inversion is represented by only the thick line and it is understood that the thin plot has the same shape there.

In FIG. 1, the horizontal (X) axis denotes time, and a vertical (Y) axis denotes voltage relative to Vcom. An interval in which the voltage ramps up so as to charge the pixel electrode from a starting level of about +2V to a peak of about +7.5 V and then the pixel electrode voltage decays (is discharged to) about +7 V denotes the duration of one frame (1F) in FIG. 1. Here Vcom is understood to be about +4.7V.

For example, a reference voltage (Vcom) may be about +5 V in one frame inversion, and the data voltages of +8 V and +2 V may be alternately applied to a given pixel electrode in successive first and second frames. That is, a positive polarity data voltage (e.g., 3 Volts above 5V) and a negative polarity data voltage (e.g., 3 Volts below 5V) are alternately applied on a one-per-frame basis. In the first frame, if the positive polarity data voltage of 8 V is applied (e.g., through a thin film transistor or TFT having a forward drop of about 0.5V), the voltage charged in the pixel is first increased from 2 V to 7.5 V during a TFT-on period (a 1H period) and then it discharges to about 7 V due to leakage currents. In the second frame, if the negative polarity data voltage of 2 V is applied (e.g., through a TFT having a forward drop of about 0.5V), the voltage charged in the pixel is reduced from 7 V to 2.5 V during a TFT-on period (a 1H period) and then discharged to 2 V due to leakage currents over a decay period of about 1F in length.

In the case of inversion being applied every two frames, the respective data voltage levels of 8 V and 2 V may be alternately applied every two frames. That is, the positive polarity data voltage and the negative polarity data voltage are alternately applied on a two-frame (2F) basis. More specifically, in the first frame, if the positive polarity data voltage of 8 V is applied, the voltage charged in the pixel is increased from 2 V to 7.5 V and then discharged to 7 V (due to leakage currents over a decay period of about 1F in length). In the next successive or second frame, the positive polarity data voltage of 8 V is again applied, and this time the voltage charged in the pixel is increased from 7 V to 8 V (because only a small current flows through the TFT and thus its forward drop is smaller; almost zero). Then during the remainder of the 1F period when the TFT is turned off, the pixel electrode discharges to about 7.5 V due to leakage currents over the decay period of about 1F in length. In other words, the voltages obtained in the second frame (F2nd) of the two-frame inversion scheme (2FIS) are not the same as those obtained in the first frame (F1st) of the two-frame inversion scheme.

Therefore, in the case of the two frame inversion scheme (2FIS), there is a problem in that when data having the same polarity and magnitude are continuously applied for two successive frames this causes an overcharging in the second frame (F2nd) and this can lead to perception of luminance defects.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention provides a display device and method of driving the same that prevents the occurrence of overcharging in for example two frame inversion scheme (2FIS), thus preventing luminance defects associated with such overcharging.

An exemplary embodiment display device in accordance with the present disclosure includes: a display panel including a gate line, a data line, and a pixel unit connected to the gate line and the data line, a signal controller generating control signals for driving the display panel, a gate driver applying a gate voltage to the gate line, and a data driver applying a data voltage to the data line according to a data load timing signal received from the signal controller as one of the control signals, wherein the data load timing signal includes a first load signal pulse applied to the data driver when the data voltage having polarity that is different from the polarity of the data voltage of a prior frame is applied, and a different second load signal pulse applied to the data driver when the data voltage having the polarity that is the same as the polarity of the data voltage of the prior frame is applied, and where a width of the second load signal pulse is larger than a width of the first load signal pulse.

A period between first load signal pulses is the same as a period between second load signal pulses.

The polarity of the data voltage applied to the pixel may be inverted every two frames.

The gate voltage may include a gate-on voltage level and a gate-off voltage level, the gate-on voltage may be applied only to odd numbered gate lines in a first of two successive frames in both of which the data voltages having a same polarity are applied, and the gate-on voltage level may be applied only to even numbered gate lines in the other frame.

The data voltage displaying an image for a left eye may be applied to the data line in a first of the two frames in which the data voltages having the same polarity are applied, and the data voltage displaying an image for a right eye may be applied to the data line in the other frame.

The polarity of the data voltage applied to the same data line in the same frame may be inverted every one pixel in a column of pixels.

The polarity of the data voltage applied to the same data line in the same frame may be inverted every two pixels in a column of pixels.

Even though the polarity of the data voltage applied to the same data line in the same frame is the same as the polarity of the data voltage applied to the prior pixel, the data driver may recognize the data load timing signal.

A driving method is provided for a display device including a gate line, a data line, and a pixel unit connected to the gate line and the data line, including: applying a first load signal pulse to a data driver, applying a data voltage having polarity that is different from the polarity of the data voltage of a prior frame to the data line according to the first load signal pulse, applying a different second load signal pulse to the data driver, and applying the data voltage having the polarity that is the same as the polarity of the data voltage of the prior frame to the data line according to the second load signal pulse, wherein a width of the second load signal pulse is larger than a width of the first load signal pulse.

The period between first load signal pulses and the period between second load signal pulses may be the same.

The polarity of the data voltage applied to the pixel may be inverted every two frames in a column of pixels.

The driving method may further include: applying a gate voltage to the gate line, wherein the gate voltage may include a gate-on voltage and a gate-off voltage, the gate-on voltage may be applied only to odd numbered gate lines in one of two successive frames in which the data voltages having the same polarity are applied, and the gate-on voltage may be applied only to even numbered gate lines in the other frame.

The data voltage displaying an image for a left eye may be applied to the data line in one of the two frames in which the data voltages having the same polarity are applied, and the data voltage displaying an image for a right eye may be applied to the data line in the other frame.

The polarity of the data voltage applied to the same data line in the same frame may be inverted every one pixel.

The polarity of the data voltage applied to the same data line in the same frame may be inverted every two pixels in a column of pixels.

Even though the polarity of the data voltage applied to the same data line in the same frame is the same as the polarity of the data voltage applied to the prior pixel, the data driver may recognize the data load timing signal.

By using different data load timing pulses in respective ones of frames having a same data polarity, a system in accordance with the present disclosure of invention can prevent occurrence of overcharging of a pixel that twice receives the same polarity for charging thereby.

### BRIEF DESCRIPTION OF THE DRAWINGS

FIG. 1 is a voltage versus time graph showing voltage level charged into a pixel electrode in a first case where driving is performed by inverting the polarity of the data voltage every frame and in a second case where driving is performed by inverting the polarity of the data voltage every two frames.

FIG. 2 is a block diagram of a display device according an exemplary embodiment in accordance with the present invention.

FIG. 3 is a view showing the polarity of the data voltage applied to each pixel of the display device according to an exemplary embodiment of the present disclosure for each frame.

FIG. 4 is a view showing signal levels developed on one pixel electrode of the display device according to the exemplary embodiment as a function of different load signals.

FIGS. 5 and 6 are views showing enlarged signals of a section of a portion of FIG. 4.

FIG. 7 is a view showing the polarity of the data voltages applied to each pixel of a display device according to another exemplary embodiment.

FIGS. 8 and 9 are views showing driving signals applied to the display device according to another exemplary embodiment.

### DETAILED DESCRIPTION

Hereinafter, the present disclosure of invention will be provided more fully hereinafter with reference to the accompanying drawings, in which exemplary embodiments are shown. As those skilled in the art would realize, the described embodiments may be modified in various different ways, all without departing from the spirit or scope of the present teachings.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

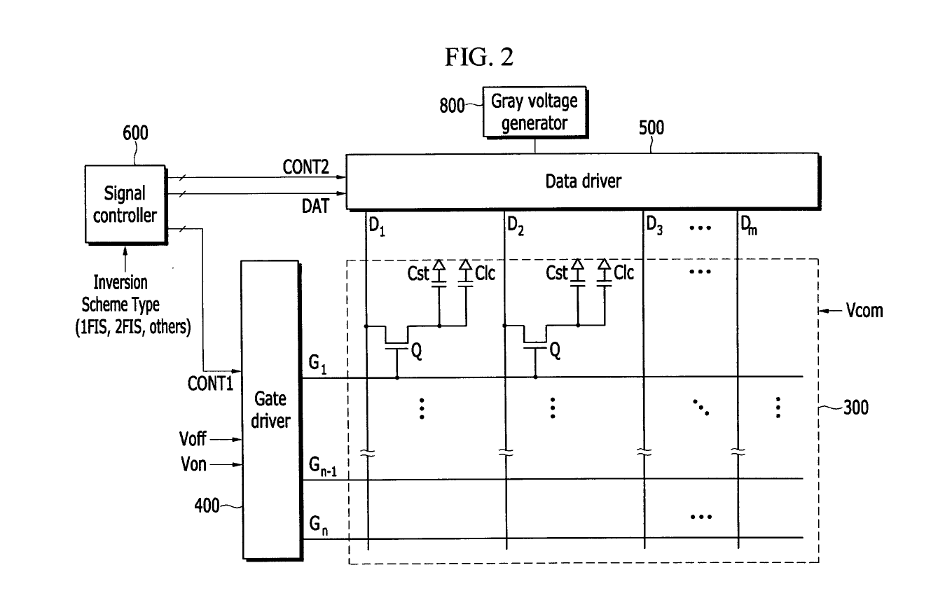

First, referring to FIG. 2, a display device according to an exemplary embodiment of the present disclosure will be described below.

FIG. 2 is a block diagram of a display device according an exemplary embodiment of the present disclosure of invention.

The display device 1000 according to the exemplary embodiment shown in FIG. 2, includes a display panel 300 configured for displaying an image and a signal controller 600 configured for controlling signals for driving the display panel 300.

The display panel 300 may display an image according to image data DAT outputted from the signal controller 600.

The display panel 300 includes a plurality of gate lines G1-Gn and a plurality of data lines D1-Dm, a plurality of gate lines G1-Gn extend in a horizontal direction, and a plurality of data lines D1-Dm cross a plurality of gate lines G1-Gn and extend in a vertical direction.

One of gate lines G1-Gn and one of data lines D1-Dm are respectively connected to a respective one of plural pixel units, and each pixel unit includes a respective switching element Q connected to the corresponding gate line G1-Gn and to the corresponding data line D1-Dm. A control terminal (gate) of the switching element Q is connected to a respective one of the gate lines G1-Gn, an input terminal (source) thereof is connected to the respective data line among D1-Dm, and an output terminal (drain) thereof is connected to a pixel electrode of a corresponding liquid crystal capacitor C_{lc} and also to a respective storage capacitor Cₛₜ.

The display panel 300 of FIG. 2 is shown as a liquid crystal panel, but examples of the display panel 300 to which the present invention may be applied may include various other kinds of display panels in which discharge of a pixel-controlling capacitance occurs such as in an organic light emitting (OLED) panel, in an electrophoretic display panel, and in a plasma display panel in addition to that which occurs in the liquid crystal panel.

The signal controller 600 suitably treats the image data DAT and the control signal thereof transferred from the outside for an operation condition of the liquid crystal panel 300 in response to, for example, a vertical synchronization signal Vsync, a horizontal synchronizing signal Hsync, a main clock signal MCLK, a data enable signal DE and the like, and then generates and outputs a gate control signal CONT1 and a data control signal CONT2. The signal controller 600 may receive from an external source, an inversion scheme type signal (e.g., 1FIS, 2FIS, Other) which indicates the type of polarity inversion (if at all) to be used where the type of polarity inversion can include at least a once per frame inversion scheme (1FIS) and a once every two frames inversion scheme (2FIS). Alternatively or additionally, the signal controller 600 may include an internal memory (e.g., a reprogrammable memory) that stores an indication of the type of polarity inversion (if at all) that is currently to be used.

The gate control signal CONT1 includes a vertical synchronization start signal STV instructing a start of an output of a gate-on pulse (a high section of the gate signal GS), a gate clock signal CPV controlling an output time of the gate-on pulse, and the like.

The data control signal CONT2 includes a horizontal synchronization start signal STH instructing a start of an input of the image data DAT, a data load timing signal TP for applying the corresponding data voltage to the data line D1-Dm, and the like. The data load timing signal TP is separately shown and, as will become apparent in the below, the signal controller 600 is configured to cause the data load timing signal TP to change in accordance with the supplied inversion scheme type signal or the memory-indicated inversion scheme type.

The display device according to the exemplary embodiment of the present invention may further include a gate driver 400 driving the gate line G1-Gn and a data driver 500 driving the data line D1-Dm. In one embodiment, the data driver 500 is responsive to a falling edge of the load timing signal TP (timing pulse) as providing a timing for when new data voltages are to be charged onto the data lines in correspondence with each horizontal scan period (1H) of each new frame (1F).

The plurality of gate lines G1-Gn of the display panel 300 are connected to the gate driver 400, and the gate driver 400 alternately applies the gate-on voltage Von and the gate-off voltage Voff to the gate lines G1-Gn according to the gate control signal CONT1 applied from the signal controller 600.

The display panel 300 may be formed of two substrates bonded while facing each other, and the gate driver 400 may be formed so as to be attached to an edge of one side of the display panel 300. Further, the gate driver 400 may be monolithically integrated together with the gate lines G1-Gn, the data lines D1-Dm, and the switching element Q on the display panel 300. That is, the gate driver 400 may be formed together in a process of forming the gate lines G1-Gn, the data lines D1-Dm, and the switching element Q.

The plurality of data lines D1-Dm of the display panel 300 are connected to the data driver 500, and the data driver 500 receives the data control signal CONT2 and the image data DAT from the signal controller 600. The data driver 500 converts the image data DAT into the data voltage by using a gray voltage generated in a gray voltage generator 800, and transfers the data voltage to the data lines D1-Dm.

The data voltage is formed of a selected one of a positive polarity data voltage and a negative polarity data voltage. The positive polarity data voltage has a value that is higher than a reference voltage (Vcom), and the negative polarity data voltage has a value that is lower than the reference voltage.

The data voltage is applied to a plurality of pixels connected to the data lines D1-Dm when the gate-on voltage Von is applied to the corresponding gate lines G1-Gn to turn on the switching element Q, thus performing charging. Hereinafter, a voltage charged in the pixel is called a ‘pixel voltage’.

The pixel to which the positive polarity data voltage is applied is charged by the positive polarity pixel voltage, and the pixel to which the negative polarity data voltage is applied is charged by the negative polarity pixel voltage.

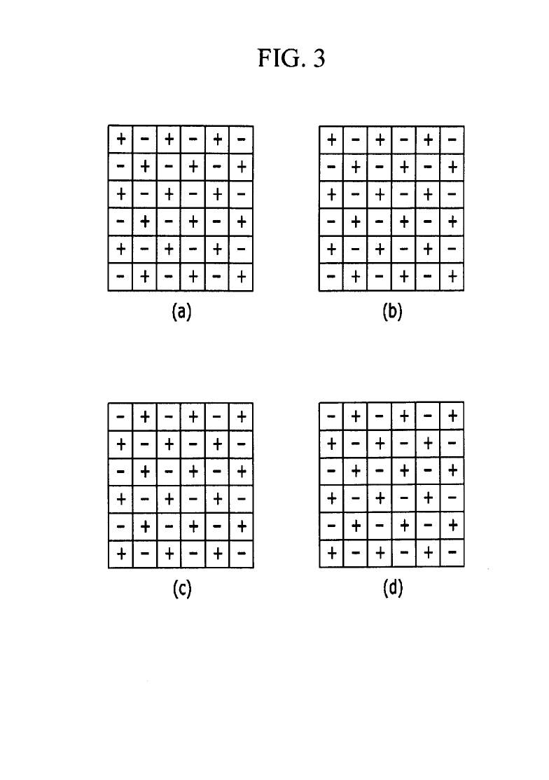

Hereinafter, referring to FIG. 3, polarity of the data voltage applied to each pixel of the display device according to the exemplary embodiment will be described.

FIG. 3 is a view showing the polarities of the data voltages applied to each pixel of the display device according to the exemplary embodiment for each frame when the two frame inversion scheme (2FIS) is active.

FIG. 3(a) shows the polarities of the data voltages applied to each pixel in the respective first and subsequent rows of the first frame (F1st). FIG. 3(b) shows the polarities of the data voltages applied to each pixel in the respective first and subsequent rows of the second frame (F2nd). FIG. 3(c) shows the polarities of the data voltages applied to each pixel in the respective first and subsequent rows of the third frame (F3rd) and FIG. 3(d) shows the polarities of the data voltages applied to each pixel in the respective first and subsequent rows of the fourth frame (F4th). A repeat of the data voltages of the pattern like FIG. 3(a) is applied in the fifth frame (F5th), and the polarity patterns of the data voltages is likewise repeated in the same order of FIGS. 3(b) to 3(d), 3(a), . . . etc. for subsequent frames when the two frame inversion scheme (2FIS) is active.

First, referring in more detail to FIG. 3(a), a positive polarity data voltage (+) is applied to the pixel positioned at the first row and the first column in the first frame. Referring to FIG. 3(b), the positive polarity data voltage (+) is again applied to the pixel positioned at the first row and the first column in the second frame. Referring to FIG. 3(c), a negative polarity data voltage (−) is applied to the same pixel positioned at the first row and the first column in the third frame. Referring to FIG. 3(d), the negative polarity data voltage (−) is again applied to the pixel positioned at the first row and the first column in the fourth frame. That is, the pattern having the polarity applied to each pixel in one frame is formed by a vertical one dot inversion manner, and the polarity of the data voltage applied to the same pixel is formed by a two frame inversion manner where the polarity is inverted every two frames.

Checking the polarity of the data voltage applied to the pixel positioned at the first row and the second column, the negative polar-negative polar-positive polar-positive polarity patterns are ensured. The data voltage having the polarity that is opposite to that of the pixel positioned at the first row and the first column is applied to the pixel positioned at the first row and the second column, and inversion pattern is exhibited every two frames.

In FIG. 3, the pixels adjacent in a row direction and a column direction exhibit different polarities, but the present disclosure is not limited thereto, the polarities applied to all pixels in one frame may be the same as each other, or the polarities applied to the pixels adjacent in a row direction or a column direction may be the same as each other.

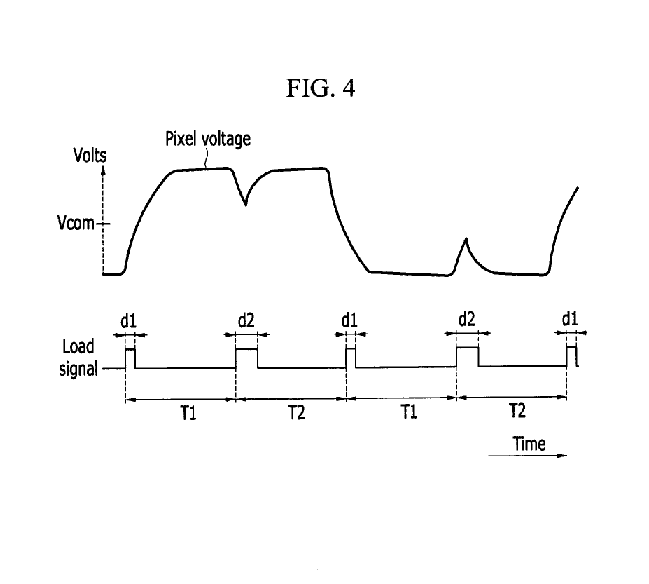

Hereinafter, referring to FIGS. 4 to 6, the pixel voltage that is charged into each pixel electrode (e.g., main pixel electrode) of each pixel of the display device according to the exemplary embodiment will be described.

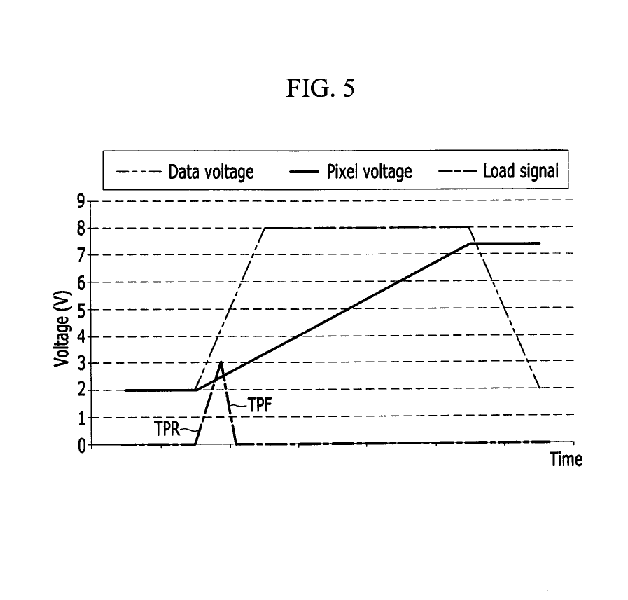

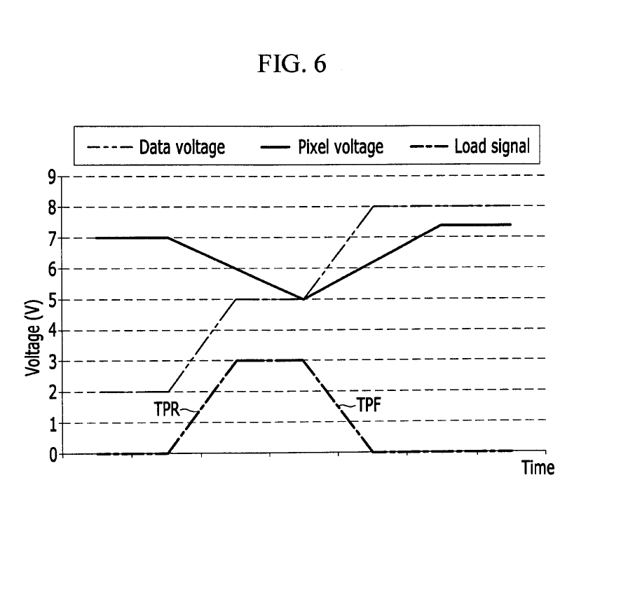

FIG. 4 is a voltage versus time view showing signals applied to one pixel of the display device according to the exemplary embodiment, and FIGS. 5 and 6 are views showing enlarged signals of a section of a portion of FIG. 4; in particular where the timing of the falling edge of data-load timing pulse (TP) is varied.

More specifically, FIG. 4 shows the corresponding load signal (TP) for a given one pixel when the corresponding pixel voltage is charged into that one pixel in each of respective first and second frames (T1, T2) while the two frame inversion scheme (2FIS) is in effect. However, the load signal (TP) is supplied row by row whenever the corresponding data voltages are applied in practice, which other rows and there TP pulses are omitted in the drawings so that focus is on the one given pixel.

The positive polarity pixel voltage is first charged into the one given pixel when the falling edge of the corresponding load signal (of duration d1) is applied in the first frame (F1st). The positive polarity pixel voltage is again begun to be charged into the one given pixel when the falling edge of the corresponding load signal (of duration d2) is applied in the second frame (F2nd). The negative polarity pixel voltage is begun to be charged into the one given pixel when the falling edge of the corresponding load signal (of duration d1) is applied in the third frame (F3rd). The negative polarity pixel voltage is again begun to be charged into the one given pixel when the falling edge of the corresponding load signal (of duration d2) is applied in the fourth frame (F4th). Then the pattern is repeated. That is, the polarity is inverted every two frames to allow the pixel voltage to be charged in the positive polar-positive polar-negative polar-negative polarity order.

As shown in FIG. 4, when the two frame inversion scheme (2FIS) is in effect the load signal is formed of a first load signal pulse and a different second load signal pulse. The first load signal pulse (of duration d1) is applied to the data driver when the data voltage having the polarity that is different from that of the previous data voltage of the prior frame is applied to the respective one pixel. The second load signal pulse (of duration d2) is applied to the data driver when the data voltage having the polarity that is the same as that of the previous data voltage of the prior frame is applied to the respective one pixel. Accordingly, the first load signal pulse (of duration d1) is applied in the first frame and in the third frame, etc. while the second load signal pulse (of duration d2) is applied in the second frame and in the fourth frame, etc.

In one embodiment, all the load signal pulses (TP) have rising edges positioned the same way along the time line for every frame, however, the width d1 of the first load signal pulse is different from the width d2 of the second load signal pulse and thus the relative timing of the falling edge is different. More specifically, the width d2 of the second load signal pulse may be larger than the width d1 of the first load signal pulse. The period T1 of the frame of the first load signal and the period T2 of the frame of the second load signal are the same as each other. The first load signal pulse and the second load signal pulse are alternately applied. The time T1 required from the start of the first load signal pulse until the second load signal pulse is applied is the same as the time T2 required until the third load signal pulse (of duration d1) is applied in the third frame.

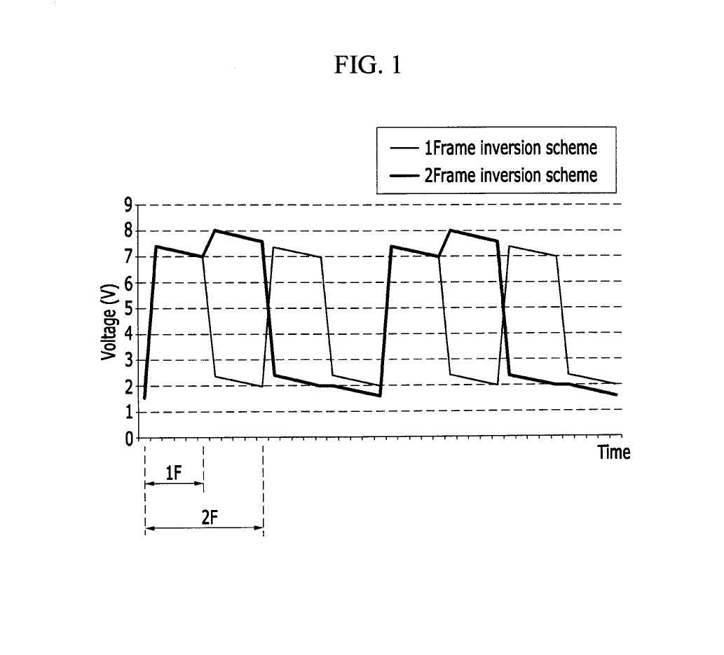

Referring to a more detailed embodiment of FIG. 5 and showing a portion of an early stage of the first frame, the first load signal pulse is shown to have a rising edge (TPR) and a falling edge (TPF). When the falling edge (TPF) occurs, an analog voltage that is to be applied to the data line is applied and this causes the pixel electrode whose TFT is turned on to begin charging through that TFT so as to increase the pixel electrode voltage from an initial value of say, 2 V toward a destination voltage of 8 V. The RC time constant is relatively large and therefore the pixel electrode voltage (PE) also slowly increases as it is charged, from 2 V to 7.5 V. That is, the positive polarity pixel voltage is charged into the pixel during the duration starting with the falling edge (TPF) of the load signal (TP) and ending with the shutting off of the gate turn on voltage (Von) which happens to coincide with when the applicable data line signal DL begins to switch to a new value. Although not shown in FIG. 5, the charged pixel voltage may then be slowly discharged (due to leakage currents) and reduced to about 7 V when the first frame is finished as is better shown in FIG. 1.

Referring to FIG. 6 which is showing a portion of an early stage of the second frame and for the same pixel, the second load signal pulse also has a respective rising edge (TPR) and a falling edge (TPF) and a longer duration therebetween. This second load signal pulse is applied at a time when the applicable data line voltage is switching; but the falling edge (TPF) is intentionally delayed so as to thereby reduce a remaining time duration in which the pixel electrode (PE) slowly charges toward the sourced to 8 V level (sourced to the input terminal of the pixel's TFT (not shown)). During the switching time, the applicable data voltage may be increased from 2 V to 5 V, maintained at that Vcom level for a while, and then increased to the 8 V drive level. The charging up toward the 8 V drive level of the pixel electrode (PE) does not start until the time that the falling edge (TPF) of the load signal occurs, and accordingly, the pixel is not charged to the full 8 V drive level but rather only to about 7.5V. In one variation, the then switching data voltage (which was used to drive an opposite polarity pixel of the row above) is applied to the data line at the time of the rising edge (TPR) of the load signal so as to thereby partially neutralize to about a 5V level, the level that is on the pixel electrode before the positive polarity pixel voltage is applied, and thus the voltage of the partially neutralized pixel is first reduced from 7 V to about 5 V (on average), and then it is increased to 7.5 V. That is, the pixel voltage having almost the same magnitude as the first frame is charged in the second frame even though the two frame inversion scheme (2FIS) is in effect.

In the display device according to the exemplary embodiment of the present disclosure, it is possible to prevent overcharging of a given pixel while the two frame or a higher inversion scheme (2FIS, 3FIS, etc.) is in effect by selectively increasing the width of the load signal pulse in the frame in which the data voltage having the same polarity as the prior frame is applied and using a narrower load signal pulse (TP) in the frame in which the data voltage is applied having an opposite polarity from that of the prior frame and for that given pixel.

In the above, the case where the polarities and magnitudes of the data voltages applied to the two adjacent frames are the same as each other is described, but the present disclosure of invention is not limited thereto and is applied to even the case where the polarities of the data voltages applied to the two adjacent frames are the same as each other and the magnitudes thereof are different from each other.

In a display device according to the exemplary embodiment of the present disclosure, driving may be performed so that the polarity of the data voltage is inverted every two frames. Such a two frame inversion driving scheme (2FIS) may be used for example in an interlace type driving of a display or in a 3D (3-dimension) driving of a display where in the latter case, a first frame is directed to the left eye and the next successive frame is directed to the right eye.

More specifically, in the interlace type of driving, the odd numbered gate lines and the even numbered gate lines may be alternately driven over the course of a two-frame period. For example, the gate-on voltage may be applied only to the odd numbered gate lines in the first frame, and the gate-on voltage may be applied only to the even numbered gate lines in the second frame. Alternatively, the gate-on voltage may be applied to the even numbered gate lines in the first frame, and the gate-on voltage may be applied to the odd numbered gate lines in the second frame.

In the display device according to the exemplary embodiment of the present disclosure, in the case where the interlace type driving is performed, when the data voltages having the same polarity are applied during two consecutive frames, it is possible to prevent a perceptible flicker from occurring by preventing the overcharging of respective pixels while the two frame (or higher) inversion scheme (2FIS, 3FIS, etc.) is in effect.

In the example of 3D driving, the image for the left eye and the image for the right eye may be alternately displayed over the course of a two-frame period. The image for the left eye and the image for the right eye may display different images to display a 3-dimensional image. For example, the data voltage displaying the image for the left eye may be applied in the first frame, and the data voltage displaying the image for the right eye may be applied in the second frame. Alternatively or additionally, there may be a third frame of the same polarity where an image common to both eyes is displayed.

In the display device according to the exemplary embodiment, in the case where the 3D driving is performed, when the data voltages having the same polarity are applied during two or more consecutive frames, it is possible to prevent a luminance difference between images recognized by the left eye and the right eye by preventing the overcharging of pixels that are driven two or more successive times toward a relatively large and same polarity drive value (e.g., +8V).

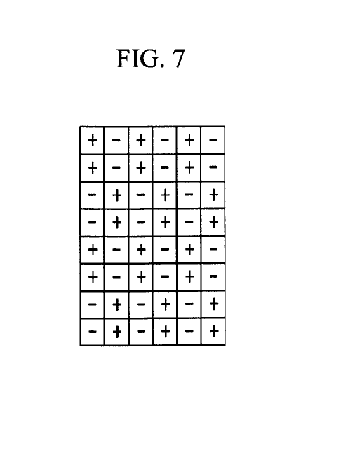

Next, referring to FIG. 7, a display device according to another exemplary embodiment will be described below.

Since the display device according to this other exemplary embodiment includes many same portions as the display device according to the first exemplary embodiment, a description thereof will be omitted and only the different portions will be described below. The largest difference with regard to the exemplary embodiment of FIG. 7 is that the inversion driving manner includes driving toward a same polarity over two or more successive rows of a frame, which will be described in more detail below.

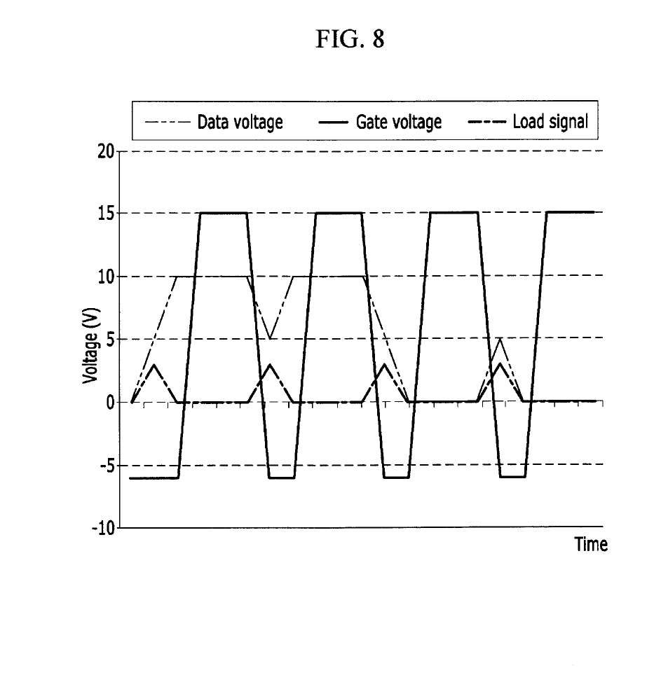

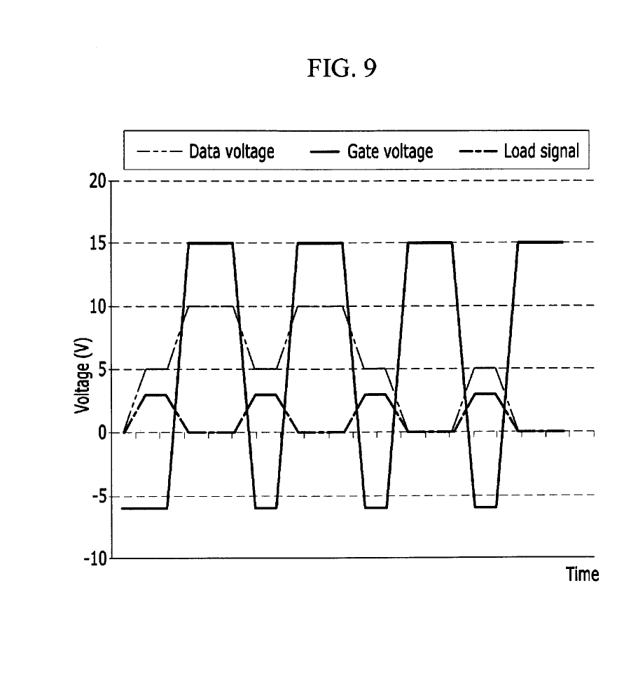

FIG. 7 is a view showing the polarity of the data voltage applied to each pixel of a display device according to the other exemplary embodiment for a given one frame. FIGS. 8 and 9 are timing diagrams showing driving signals applied to the display device according to this other exemplary embodiment of the present disclosure of invention where a same polarity is applied over two or more successive rows of a frame rather than inverting with every next row.

Checking the polarity in FIG. 7 of the data voltage applied to each pixel in one frame, it is seen that the positive polarity data voltage is applied at the first row and also to the second row and the negative polarity data voltage is applied at the third row and also to the fourth row in the first column. Subsequently, the positive polarity data voltage is applied at the fifth row and the sixth row and the negative polarity data voltage is applied at the seventh row and the eighth row.

For the second column, the negative polarity data voltage is applied at the first row and the second row and the positive polarity data voltage is applied at the third row and the fourth row. Subsequently, the negative polarity data voltage is applied at the fifth row and the sixth row and the positive polarity data voltage is applied at the seventh row and the eighth row.

The third column and the fifth column have the same polarity pattern as the first column, and the fourth column and the sixth column have the same polarity pattern as the second column.

As described above, a driving manner where different polarities are shown in a vertical direction on a two-pixel period is called the vertical two dot inversion manner. In the case where the data lines are arranged in a column direction, the polarities of the pixels connected to the same data line are inverted on a two-pixel period. That is, the polarities of the data voltages applied to the same data line during one frame are inverted on a two-pixel period.

Like the aforementioned exemplary embodiment, the load signal may be differently formed of as a combination of a first load signal pulse (e.g., narrower and/or triangle shaped pulse) and of a second load signal pulse (e.g., wider and/or trapezoid shaped pulse). In this case, the two frame inversion scheme (2FIS) may still be in effect. The first load signal pulse is applied to the data driver when the data voltage having the polarity that is different from that of the data voltage of the prior frame is applied. The second load signal pulse is applied to the data driver when the data voltage having the polarity that is the same as that of the data voltage of the prior frame is applied. Additionally, the timing of the first and second load signal pulses is synchronized to that of the gate-on voltage pulses (V_{Gon}).

The width of the first load signal pulse is different from the width of the second load signal pulse. The width of the second load signal pulse may be larger than the width of the first load signal pulse. The period between the first load signal pulses and the period between the second load signal pulses are the same as each other. The first load signal pulse and the second load signal pulse are alternately applied in respective frames; the time required until the second load signal is applied after the first load signal is applied is the same as the time required until the first load signal is applied after the second load signal is applied.

However, in the case where driving is performed by the vertical two dot inversion manner, the effect of the present disclosure of invention can be exhibited when a data sharing function is unlocked. The data sharing function is a function of one embodiment which causes a preventing of recognition by the data driver of the load signal pulse when the data voltages having the same polarity are continuously applied to the same data line. Therefore, if the data sharing function is activated, the effect by a change in width of the load signal is not exhibited.

In FIG. 7, the pixel column positioned at the leftmost side will be described as an example below.

Referring to FIG. 8, the positive polarity data voltage is supplied to the first pixel (in conjunction with activation of the first gate-on pulse). The positive polarity data voltage is also supplied to the second pixel (in conjunction with activation of the second gate-on pulse). The negative polarity data voltage is supplied to the third pixel and to the fourth pixel in the pixel column positioned at the leftmost side. In this case, each pixel is charged with the data voltage according to application of its respective first load signal pulse.

Referring to FIG. 9, here the data voltage is charged according to the application of the second load signal pulse during the second frame and while the two frame inversion scheme (2FIS) is in effect. The polarity of the data voltage supplied to each pixel is the same as that of FIG. 8. However, in the second frame, the corresponding second load signal pulses are used.

In this case, if the data sharing function is activated (undesirably activated), when the data voltage is applied to the second pixel and the fourth pixel, it is recognized as if the second load signal pulse is not applied. Accordingly, the second pixel and the fourth pixel may be overcharged (undesirably overcharged).

On the contrary, if the data sharing function is blocked (desirably blocked), even though the data voltage of same polarity is applied to the second pixel and to the fourth pixel, the second load signal pulse having the width that is larger than that of the first load signal pulse may be applied and recognized so as to thereby prevent the second pixel and the fourth pixel from being respectively overcharged (by respective positive and negative polarity data signals).

While this disclosure of invention has been provided in connection with what is presently considered to be practical exemplary embodiments, it is to be understood that the teachings are not limited to the disclosed embodiments, but, on the contrary, they are intended to cover various modifications and equivalent arrangements included within the spirit and scope of the present teachings.

What is claimed is:

1. A display device comprising:
a display panel including a gate line, a data line, and a pixel unit connected to the gate line and the data line,
a signal controller configured for generating control signals for driving the display panel, the generated control signals including a data-load timing signal,
a gate driver configured for applying a gate voltage to the gate line, and
a data driver configured for applying data voltages of different polarities to the data line in accordance with a predetermined frame inversion scheme and in accordance with a control indicated by the data-load timing signal generated by the signal controller,
wherein the data-load timing signal includes
a first load signal pulse that is communicated to the data driver when a data voltage having polarity that is different from the polarity of the data voltage of a prior frame is to be applied to the data line, and
a second load signal pulse that is communicated to the data driver when a data voltage having the polarity that is the same as the polarity of the data voltage of the prior frame is to be applied to the data line, and
a width of the second load signal pulse is larger than a width of the first load signal pulse.

2. The display device of claim 1, wherein:
a period between plural ones of the first load signal pulse is the same as a period between plural ones of the second load signal pulse.

3. The display device of claim 1, wherein:
the signal controller is configured for generating different data-load timing signals dependeing on whether the polarity of the respective data voltage applied to each respective pixel is inverted every two frames or with every frame.

4. The display device of claim 3, wherein:
the gate voltage includes a gate-on voltage level and a gate-off voltage level,
the gate-on voltage level is applied only to odd numbered gate lines in a first of two successive frames in both of which data voltages having the same polarity are applied, and the gate-on voltage level is applied only to even numbered gate lines in the other frame.

5. The display device of claim 3, wherein:
a first data voltage for a given pixel is part of an image signal for displaying a left eye image for a left eye in a first of two successive frames in both of which the data voltages having the same polarity are applied, and to second data voltage for the given pixel is part of the image signal and is for displaying a right eye image for a right eye in the other frame.

6. The display device of claim 3, wherein:
the polarity of the data voltage applied to the same data line in the same frame is inverted every pixel for a column of pixels.

7. The display device of claim 3, wherein:
the polarity of the data voltage applied to the same data line in the same frame is inverted every two pixels for a column of pixels.

8. The display device of claim 7, wherein:
even though the polarity of the data voltage applied to the same data line in the same frame is the same as the polarity of the data voltage applied to the prior pixel in the column of pixels, the data driver recognizes the data-load timing signal.

9. A driving method of a display device including a gate line, a data line, and a pixel unit connected to the gate line and the data line, comprising:
applying a first load signal pulse to a data driver of the display device during a first time duration,
first applying to the data line and in a first frame, a data voltage having a polarity that is different from the polarity of an applied data voltage of a prior frame applied to the data line, the first applying of the data voltage being controlled by the first load signal pulse,
applying a second load signal pulse to the data driver of the display device during a second time duration, and
second applying to the data line and in a second frame immediately following the first frame, a data voltage having a polarity that is the same as the polarity of the data voltage applied in the first frame, the second applying of the data voltage being controlled by the second load signal pulse,
wherein the second duration and corresponding width of the second load signal pulse is larger than the first duration and corresponding width of the first load signal pulse.

10. The driving method of a display device of claim 9, wherein:
a period between plural ones of the first load signal pulse is the same as a period between plural ones of the second load signal pulse.

11. The driving method of a display device of claim 9, wherein:
the polarity of the data voltage applied to the pixel is inverted every two frames.

12. The driving method of a display device of claim 11, further comprising:
applying a gate voltage signal to the gate line,
wherein the gate voltage signal includes a gate-on voltage level and a gate-off voltage level,
the gate-on voltage is applied only to an odd numbered gate lines in a first of two successive frames in both of which the data voltages having a same polarity are applied, and the gate-on voltage level is applied only to even numbered gate lines in the other frame.

13. The driving method of a display device of claim 11, wherein:
the data voltage displaying an image for a left eye is applied to the data line in a first of two successive frames in which the data voltages having the same polarity are applied, and the data voltage displaying an image for a right eye is applied to the data line in the other frame.

14. The driving method of a display device of claim 11, wherein:
the polarity of the data voltage applied to the same data line in the same frame is inverted every one pixel in a column of pixels.

15. The driving method of a display device of claim 11, wherein:
the polarity of the data voltage applied to the same data line in the same frame is inverted every two pixels in a column of pixels.

16. The driving method of a display device of claim 15, wherein:
even though the polarity of the data voltage applied to the same data line in the same frame is the same as the polarity of the data voltage applied to the prior pixel, the data driver recognizes the first and second load signal pulses.
